(19) United States
(12) Patent Application Publication
(10) Pub. No.: US 2003/0115817 A1
(43) Pub. Date: Jun. 26, 2003

(54) Reinforced window shutter

(75) Inventors: Grover Blackwell, Awendaw, SC (US); Jeffrey Fuquay, Charleston, SC (US)

Correspondence Address: TIMOTHY A. CASSIDY, Dority & Manning, Attorneys at Law, P.A., P.O. Box 1449, Greenville, SC, 29602, US

(73) Assignee: New Horizons Shutters, Inc.

(21) Appl. No.: 09/888,044

(22) Filed: Jun. 22, 2001

Related U.S. Application Data
(60) Provisional application No. 60/213,309, filed on Jun. 22, 2000.

(51) Int. Cl. B32B 3/04; B32B 3/00; E06B 3/70; E04C 2/54; E04C 2/38

(52) U.S. Cl. 52/456; 428/122; 428/172; 52/455; 52/784.1; 52/800.13

(57) ABSTRACT

A shutter for placement on the outside of a house or building is disclosed. The shutter is primarily made from a structural polymeric material, such as an expanded polyvinyl chloride. The shutter includes a decorative face panel that is attached to a back section. In order to consolidate the shutter, metallic channel members are placed along the vertical edges of the shutter. Once constructed, the entire shutter is then painted, which gives the shutter the appearance of a conventionally made wood shutter.

### RELATED APPLICATIONS

The present application is based upon a Provisional Application having a U.S. Serial No. 60/213,309 filed on Jun. 22, 2000.

### BACKGROUND OF THE INVENTION

In the past, most window shutters were made from wood. Unfortunately, however, wooden structures deteriorate over time when exposed to the outside environment.

As a result, shutter manufactures have recently been making shutters out of an expanded foam polyvinyl chloride. Polyvinyl chloride has better structural rigidity properties than wood and will not deteriorate as quickly as wood. Further, polyvinyl chloride is a good insulator and is fire resistant.

Polyvinyl chloride shutters constructed in the past, however, still contain various deficiencies. For instance, polyvinyl chloride shutters produced in the past have typically been made from many parts and are therefore somewhat complicated to assemble. Depending on how the shutters have been constructed, in some cases, the shutters have included channels in between the parts that have allowed water to penetrate into the shutter. These spaces and channels have posed a problem during the colder months of the year. For instance, should water freeze within the channels, there is a chance that the expansion may rupture the shutter.

Further, prior art polyvinyl chloride shutters have lacked sufficient strength for some applications. For instance, many of the shutters have been found not to have sufficient strength to withstand hurricane winds. Also, many of the shutters have not been approved for use in preservation projects. The shutters have simply not provided an appearance to make them historically correct and have, therefore, not been accepted in areas where historical covenants are in place.

As such, a need currently exists for an improved shutter made from a synthetic material, such as polyvinyl chloride. In particular, a need exists for a shutter made from a synthetic polymer that has improved strength and is easier to assemble.

### SUMMARY OF THE INVENTION

The present invention is generally directed to an improved shutter for use as a replacement to wood shutters. In one embodiment, the shutter includes a face panel made from a synthetic polymer, such as an expanded foam polyvinyl chloride. The face panel can include indented areas that have been routed out for giving the shutter an aesthetic and conventional appearance.

The face panel includes a first vertical end portion and a second vertical end portion. A back support section is attached to the face panel. The back support section can be made from a single unitary piece or from multiple pieces. The back support section can also be made from a synthetic polymer, such as an expanded foam polyvinyl chloride.

In one embodiment, the back support section includes first and second rear vertical supports. The rear vertical supports are spaced apart and extend along the vertical length of the face panel. More particularly, the first rear vertical support is positioned adjacent to the first vertical end portion, while the second rear vertical support is positioned adjacent to the second vertical end portion.

The back support section can further include at least one rear horizontal support that extends in between the pair of vertical supports. For example, in one embodiment, the shutter can include three rear horizontal supports that are positioned at the top, in the middle, and at the bottom of the face panel.

In accordance with the present invention, the shutter further includes a first channel member and a second channel member. Each of the channel members have a u-shaped cross-section. The channel members are preferably made from a metal, such as aluminum. To consolidate the construction of the shutter, the first channel member is placed over the first vertical end portion and the first rear vertical support, while the second channel member is placed over the second vertical end portion and the second rear vertical support.

In one embodiment, the first and second channel members can be slid over the vertical end portions and the rear vertical supports. Further, the vertical end portions and the rear vertical supports can include indentations. The channel members, on the other hand, can define raised elements that reside in the indentations when the channel members are assembled into place. For example, the indentations can be in the shape of slots that extend the entire length of the shutters, while the raise elements can be shaped to fit in the slots and can also extend the entire length of the shutter.

The rear vertical supports and the rear horizontal supports can be attached to the face panel in any suitable manner. In one embodiment, the rear vertical supports and the horizontal supports can be adhered to the face panel and then also nailed using either conventional nails or staples.

In one embodiment, a film can be placed in between the face panel and the rear vertical supports and the rear horizontal supports. The film can be made from a polymer, such as polyester. The film provides the shutter with impact resistance and also prevents the shutter from shattering into multiple pieces if ever damaged.

In order to give the face panel the appearance of wood, a lacquer primer can then be coated onto the face panel. Further, the entire structure can be painted once constructed.

### A BRIEF DESCRIPTION OF THE DRAWINGS

A full and enabling disclosure of the present invention, including the best mode thereof to one of ordinary skill in the art, is set forth more particularly in the remainder of the specification, including reference to the accompanying Figures in which:

FIG. 1 is a perspective view of a shutter made in accordance with the present invention;

FIG. 2 is an expanded view of the shutter illustrated in FIG. 1;

FIG. 3 is a top view of the shutter illustrated in FIG. 1; and

FIG. 4 is a back view of the shutter illustrated in FIG. 1; and

FIG. 5 is an expanded view of another embodiment of a shutter made in accordance with the present invention.

### DETAILED DESCRIPTION OF PREFERRED EMBODIMENTS

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations and their equivalents.

In general, the present invention is directed to an improved shutter. The shutter is constructed out of non-wood materials. In particular, most of the shutter is made from a synthetic polymer material. For instance, the shutter can be made from an expanded foam polyvinyl chloride (PVC). It is believed, however, that other suitable polymeric materials can also be used. Other materials may include, for instance, polyethylene, polypropylene, polystyrene, and polycarbonate.

It has been discovered that shutters made according to the present invention can have great impact resistant properties. Specifically, it is believed that the shutters will withstand hurricane tests. Further, the shutters appear as if they were made from conventional wood materials.

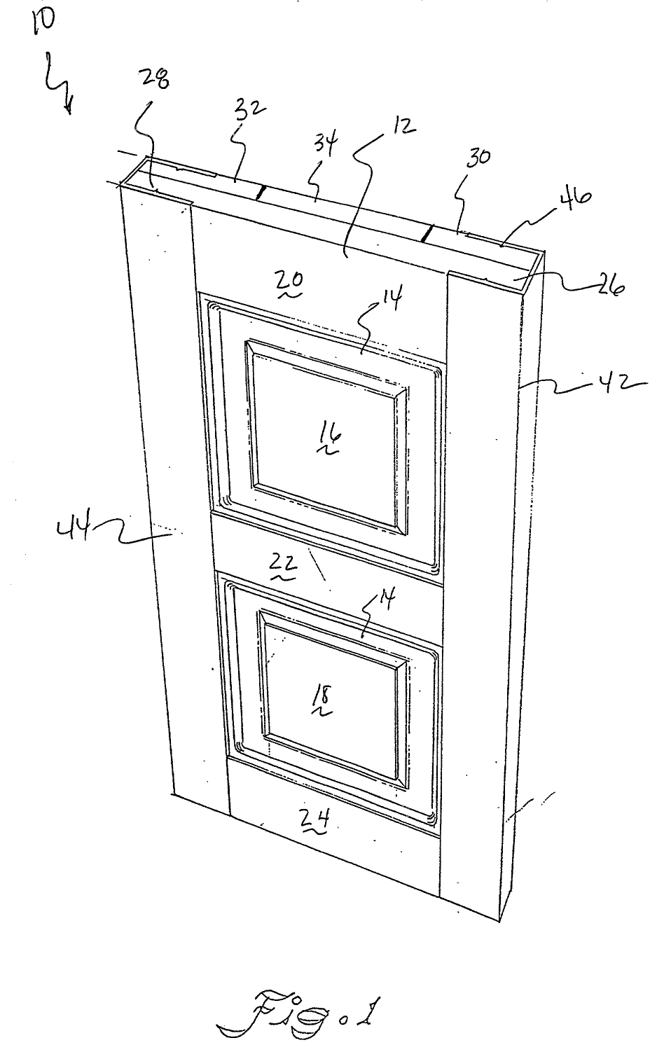

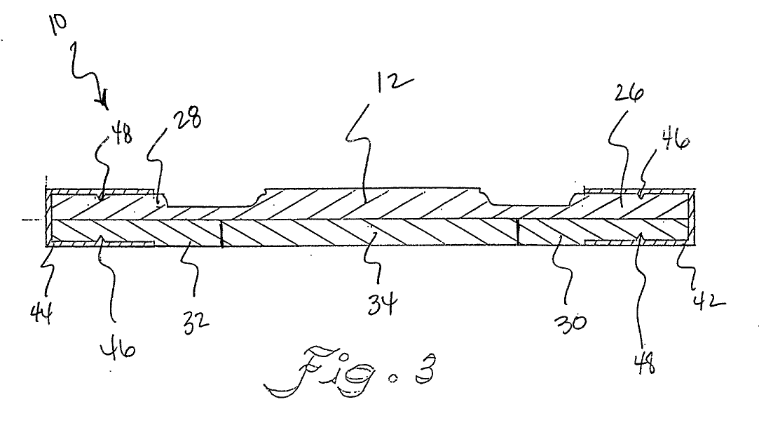

Referring to FIGS. 1-4, one embodiment of a shutter generally 10 made in accordance with the present invention is illustrated. As shown, the shutter 10 includes a face panel 12 made from a synthetic polymer, such as an expanded foam PVC. For example, face panel 12 can be made from a sheet of expanded foam polyvinyl chloride having a thickness of about one half inch. One suitable example of expanded foam polyvinyl chloride can be obtained commercially from Rommerling AG.

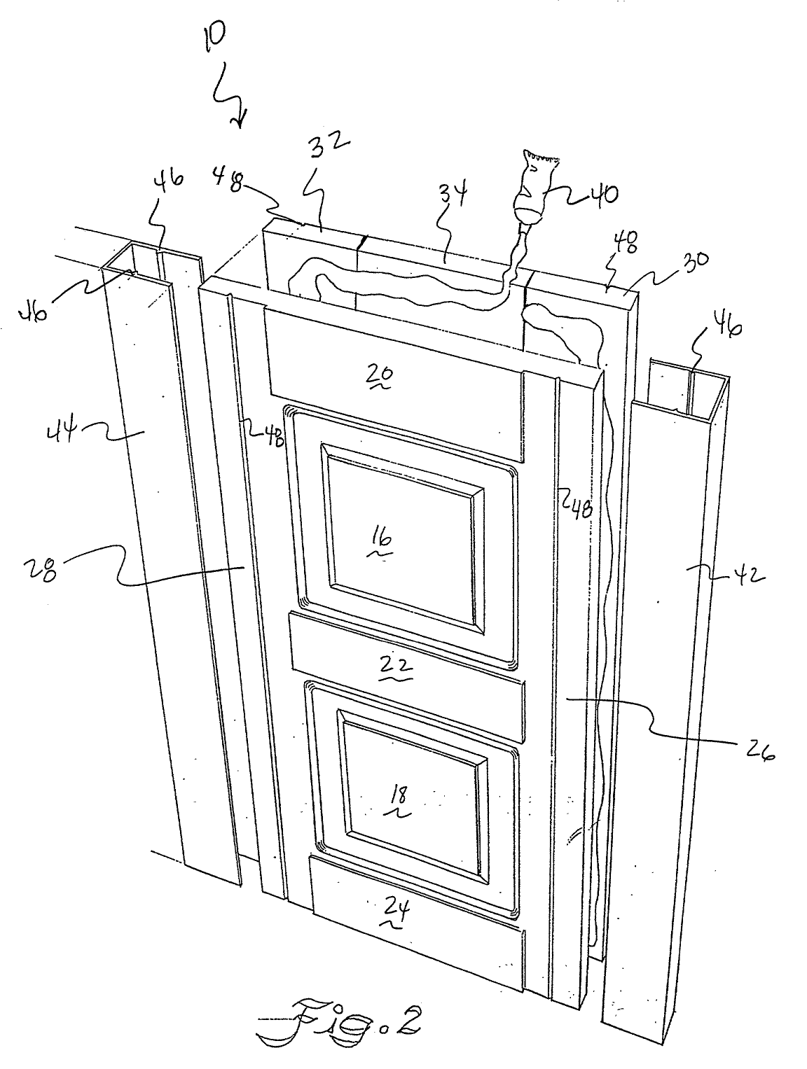

In particular, as shown in FIGS. 1 and 2, the face panel 12 includes indentations 14 where the panel has been routed out. Routed out areas 14 give the face panel an aesthetic appearance and make the panel resemble conventionally made shutters. It should be understood, however, that the face panel 12 can have any desired design and the embodiment illustrated herein is but one embodiment of the present invention.

In this embodiment, the face panel 12 includes a first decorative panel 16 and a second decorative panel 18. Decorative panels 16 and 18 are separated by a top rail 12, a center rail 22, and a bottom rail 24. As shown, the face panel 12 further includes a first vertical end portion 26 and a second end vertical end portion 28.

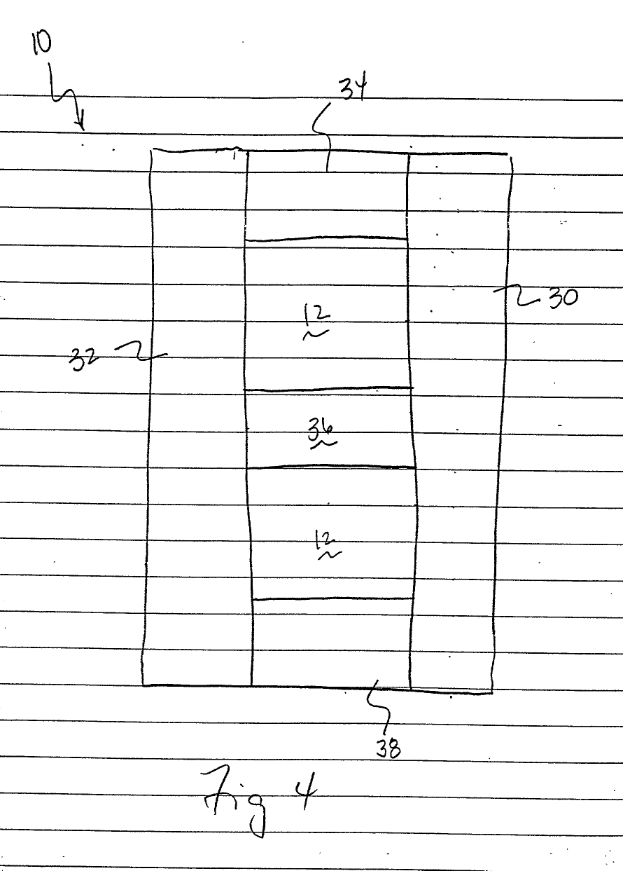

In order to reinforce the face panel 12, the shutter 10 further includes back support section(s). For example, as shown in FIG. 4, one embodiment of the shutter 10 includes five (5) back support sections 30, 32, 34, 36, and 38. In particular, as shown in FIG. 4, the shutter 10 includes a first rear vertical support 30 placed adjacent to the first vertical end portion 26 and a second rear vertical support 32 place adjacent to the second vertical end portion 28. Extending in between the rear vertical supports 30 and 32 are three rear horizontal supports 34, 36 and 38. The rear vertical supports and the rear horizontal supports are preferably made from the same material and have the same thickness as the face panel. For instance, the rear vertical supports and the rear horizontal supports can be made from an expanded foam polyvinyl chloride having a thickness of about one half inch. It should be understood, however, that the entire back support section can be made from a unitary piece.

In general, any suitable attachment device can be used to attach the rear vertical supports and the rear horizontal supports to the face panel. As shown in FIG. 2, for instance, one embodiment of the present invention utilizes an adhesive 40 as an attachment device. For example, when the shutter 10 is constructed from polyvinyl chloride parts, the adhesive 40 can be a polyvinyl chloride glue, such as one commercially sold by 3M Corporation. In one embodiment, besides an adhesive 40, the rear vertical supports and the rear horizontal supports can also be nailed to the face panel 12 using, for instance, conventional nails or staples.

As shown in FIGS. 1-3, in order to consolidate the entire structure, the shutter 10 can further include a first channel member 42 and a second channel member 44 that enclose the vertical edges of the shutter 10. The channel members 42 and 44 are preferably made from a metal. For example, in one embodiment, the channel members 42 and 44 are made from aluminum having a thickness of from about one sixteenth of an inch to about one eighth of an inch.

The channel members 42 and 44 can be slid onto a shutter over vertical end portions 26 and 28 and rear vertical supports 30 and 32. An adhesive such as the one described above, can be used to adhere the channel members to the end portions and the end vertical supports.

In order to better secure the first and second channel members 42 and 44 to the face panel and to the rear vertical supports, the channel members can include raised portions 46 that fit into grooves 48 formed into the vertical end portions and the rear vertical supports. In this manner, the channel members 42 and 44 interlock with the face panel 12 and the rear vertical supports.

It should be understood, however, that various other interlocking structures can be used in order to secure the channel members to the shutter. For instance, various other tongue and groove type configurations can be used. Moreover, although the Figures show each side of the shutter containing two grooves, it should be understood that grooves can also be placed into the sides of the shutter. In addition, the channel members can also include raised portions corresponding to grooves placed into the sides of the shutter.

The polyvinyl chloride material used in the present invention is generally porous. In order to create a smoother surface, the polyvinyl chloride can be coated with a lacquer primer to provide a smoother finish. In particular, the face panel 12 can be coated with a lacquer primer.

Once a shutter 10 is constructed such as described above, the entire shutter 10 can be painted to any suitable color. Once painted, the difference between the aluminum channel members and the polyvinyl chloride face panel becomes indiscernible. In some embodiments, it may also be desirable to further reinforce the shutter 10, such as shown in FIG. 1. For instance, in one embodiment, a polymer film can be positioned in between the face panel and the rear vertical supports in between the face panel and the rear horizontal supports. The film can be chosen to have anti-shattering properties. For instance, the film can be a polyester film containing “KEVLAR” fibers. Other suitable films may include, for example, plexiglass or a polycarbonate film. When placed between the panels, the film will prevent the shutter from shattering into many pieces if ever subjected to a tremendous force. Although not required, this embodiment may be particularly well-suited for use in coastal areas that are subject to the threat of hurricanes.

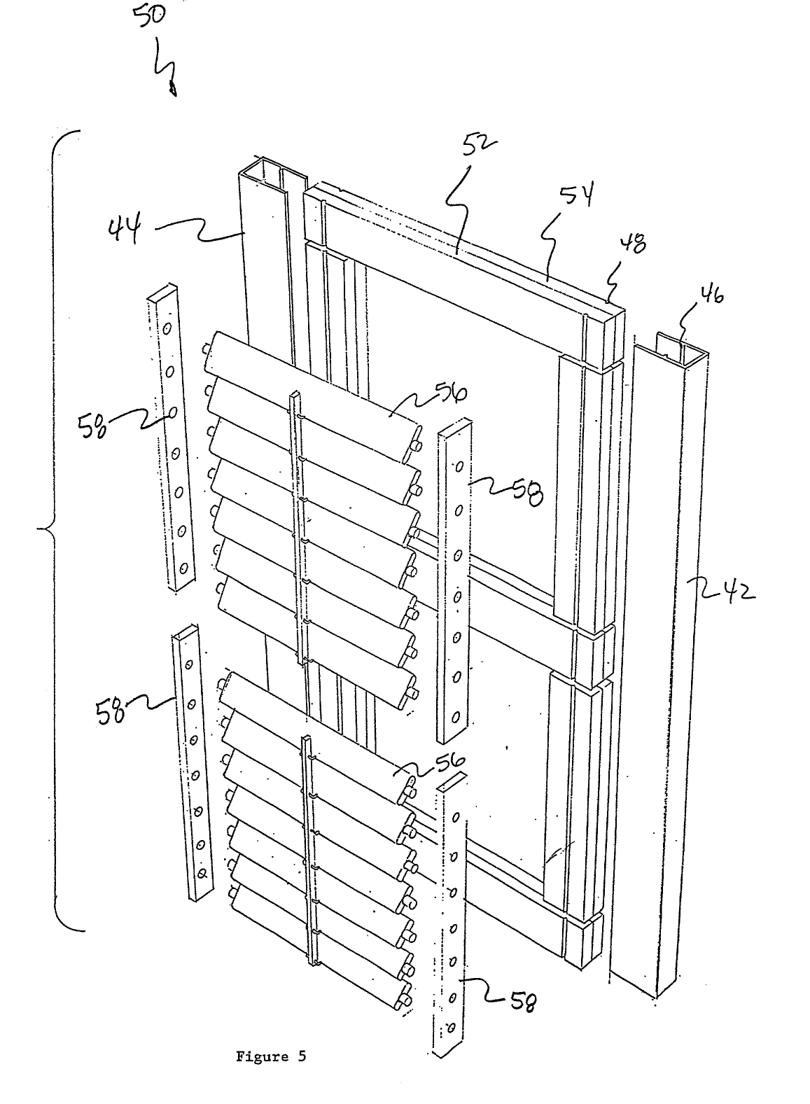

Referring to FIG. 5, an alternative embodiment of a shutter generally 50 made in accordance with the present invention is shown. In this embodiment, the shutter 50 includes a face panel 52 that contains two cutout sections. In the drawing, the face panel 52 is shown to be made in multiple parts. It should be understood, however, that the face panel 52 can be made from a single unitary piece. As shown, the face panel 52 is attached to a back panel 54 that generally has the same shape as the face panel 52.

In this embodiment, the shutter 50 includes two sets of louvers 56. The louvers 56 are generally made from a synthetic polymer, such as polyvinyl chloride and are decorative, but non-functional. The louvers 56 include pins that are inserted into strips 58, which are in turn adhered to a front panel 52. In one embodiment, however, the face panel 52 can include pin holes, thus eliminating the need for strips 58.

Similar to the embodiment illustrated in FIG. 1, the shutter 50 can further include a first channel member 42 and a second channel member 44 that are attached to the shutter 50 as described above.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A shutter comprising:
a face panel made from a synthetic polymer, said face panel including a first vertical end portion and a second vertical end portion;
a first rear vertical support and a second rear vertical support attached to said face panel, said rear vertical supports being spaced apart and extending along the length of said face panel, said first rear vertical support being positioned adjacent to said first vertical end portion and said second rear vertical support being positioned adjacent to said second vertical end portion; and
at least one rear horizontal support attached to said face panel, said rear horizontal support extending in between said pair of rear vertical supports; and
a first channel member and a second channel member, each of said channel members having a u-shaped cross-section and being made from a metal, said first channel member being placed over said first vertical end portion and said first rear vertical support and said second channel member being placed over said second vertical end portion and said second rear vertical support.

2. A shutter as defined in claim 1, wherein said face panel is made from an expanded foam polyvinyl chloride.

3. A shutter as defined in claim 2, wherein said first and second rear vertical supports and said at least one rear horizontal support are made from an expanded foam polyvinyl chloride.

4. A shutter as defined in claim 1, wherein said first and said second rear vertical supports are attached to said face panel using an adhesive.

5. A shutter as defined in claim 1, wherein each of said vertical end portions and said rear vertical supports include indentations, and wherein said channel members define raised elements that reside in said indentations.

6. A shutter as defined in claim 1, wherein said face panel is coated with a lacquer coating.

7. A shutter as defined in claim 1, wherein said shutter includes as least two rear horizontal supports.

8. A shutter as defined in claim 1, wherein said first and said second channel members are made from aluminum.

9. A shutter as defined in claim 1, wherein said face panel includes routed out decorative areas.

10. A shutter as defined in claim 1, further comprising a polymer film positioned in between said face panel and said first and said second rear vertical supports and between said face panel and said at least on horizontal support.

11. A shutter comprising:
a face panel made from a synthetic material, said face panel including a first vertical end portion and a second vertical end portion;
a back panel comprising first and second rear vertical supports attached to said face panel, said rear vertical supports being spaced apart and extending along the length of said face panel, said first rear vertical support being positioned adjacent to said first vertical end portion and said second rear vertical support being positioned adjacent to said second vertical end portion, said first and second rear vertical supports being made from a synthetic material; and
a first channel member and a second channel member, each of said channel members having a u-shaped cross-section, said first channel member being placed over said first vertical end portion and said first rear vertical support, said second channel member being placed over said second vertical end portion and said second rear vertical support.

12. A shutter as defined in claim 11, wherein said first and said second channel members are made from aluminum.

13. A shutter as defined in claim 11, wherein said face panel and said back panel are made from a material comprising an expanded foam polyvinyl chloride.

14. A shutter as defined in claim 11, wherein each of said vertical end portions and said rear vertical supports include indentations and wherein said channel members define raised elements that reside in said indentations.

15. A shutter as defined in claim 14, wherein said first and said second channel members extend the entire length of said face panel.

16. A shutter as defined in claim 15, wherein said indentations located on said vertical end portions and said rear vertical supports comprise vertical slots that extend the length of said shutter, and wherein said raised elements defined by said channel members also extend the length of said shutter.

17. A shutter comprising:
a face panel made from an expanded foam polyvinyl chloride, said face panel including a first vertical end portion and a second vertical end portion;
a rear support section attached to said face panel, said rear support section including a first rear vertical support and a second rear vertical support, said first and second rear vertical supports being made from an expanded foam polyvinyl chloride, said first rear vertical support being positioned adjacent to said first vertical end portion and said second rear vertical support being positioned adjacent to said second vertical end portion; and
a first channel member and a second channel member, each of said channel members having a u-shaped cross-section and being made from a metal, said first channel member being placed over said first vertical end portion and said first rear vertical support, said second channel member being placed over said second vertical end portion and said second rear vertical support, and wherein each of said vertical end portions and said rear vertical supports include an indentation and wherein said channel members define raised elements that reside in said indentations.

18. A shutter as defined in claim 17, wherein said back support section further includes at least one horizontal support extending in between said pair of rear vertical supports.

19. A shutter as defined in claim 17, wherein said first and said second channel members are made from aluminum.

20. A shutter as defined in claim 17, wherein said indentations located on said vertical end portions and said rear vertical supports comprise vertical slots that extend the length of said shutter, and wherein said raised elements defined by said channel members also extend the length of said shutter.
